(19) United States
(12) Patent Application Publication
(10) Pub. No.: US 2009/0003712 A1
(43) Pub. Date: Jan. 1, 2009

(54) Video Collage Presentation

(75) Inventors: Tao Mei, Beijing (CN); Xian-Sheng Hua, Beijing (CN); Shipeng Li, Redmond, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 12/055,267

(22) Filed: Mar. 25, 2008

Related U.S. Application Data
(60) Provisional application No. 60/946,956, filed on Jun. 28, 2007.

(51) Int. Cl. G06K 9/62

(52) U.S. Cl. 382/225

(57) ABSTRACT

A method, a computer-readable storage media, and a user interface describe techniques for creating a video collage synthesized from video content, selecting representative images from the video content, extracting and resizing regions of interest (ROI) from the representative images from the video content, and arranging the regions of interest on a canvas without seams while preserving a temporal structure of the video content. The described method, computer-readable storage, and user interface enhance the experience of the user in browsing a video collage that is compact.

### RELATED APPLICATIONS

The present application claims priority to U.S. Patent Application Ser. No. 60/946,956, Attorney Docket Number MS1-3567USP1, entitled, “Video Collage”, to Mei et al., filed on Jun. 28, 2007, which is incorporated by reference herein for all that it teaches and discloses.

### TECHNICAL FIELD

The subject matter relates generally to video representation, and more specifically, to presenting a video collage from a video sequence for efficient video browsing.

### BACKGROUND

Representing multimedia in different formats presents many challenges. For instance, the quantity of multimedia data is increasing dramatically in recent years with the popularity of digital capturing devices. While online delivery of video content surged to an unprecedented level in current years, users now face an enormous amount of videos. However, problems include how to effectively and efficiently represent important information encoded in video data while removing redundancy. Another problem is how to represent video content for efficient browsing of video data, whether the video is an unedited home video, a professional video program, or an online video clip.

Various techniques have been attempted to present video content. One technique is a video booklet system that selects a set of thumbnails from an original video and prints the thumbnails out on a predefined set of templates in a variety of forms. However, the predefined booklet templates usually lack a compact layout, since a focus of the video booklet is to support artistic templates and personalized delivery. Another technique is a video summary, which is a stained-glass visualization where the key-frames with an interesting area are packed and visualized like a stained-glass with irregular shapes. The drawback is that stained-glass is not very visually pleasing due to the irregular shapes as well as the unsmooth transitions between these shapes.

There are two more techniques in presenting video content. One is a pictorial summary of video content, which arranges video poster in a timeline to tell an underlying story. Another technique is a video snapshot which is total solution of compact static video summarization. These techniques lack a satisfying presentation layout. Therefore, it is desirable to find ways to construct a collage from a video sequence to understand the video content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In view of the above, this disclosure describes various exemplary methods, computer program products, and user interfaces for providing a compact synthesized video collage for efficient video browsing. The video collage is constructed from a video sequence of video content by selecting representative images from the video content, extracting and resizing regions of interest (ROI) from the representative images from the video content. The described techniques arrange regions of interest on a canvas and preserve a temporal structure of the video content in terms of a layout in the video collage. The video collage offers viewing advantages and convenience to a user of a computing device. The video collage is efficient for browsing large amounts of data in a video presentation while preserving a storyline.

Also, this disclosure illustrates formulating an energy equation that maximizes representativeness of the video content and minimizes transition to address regions of interest for extraction and blending. Furthermore, this disclosure improves a user interface experience by automatically constructing a compact and visually appealing synthesized collage from a video sequence for efficient video browsing. The user may browse video content in a variety of more efficient ways such as in a one dimensional collage, a two dimensional collage, a dynamic or a static collage, key frames, video clips and video content corresponding to the video collage. Thus, the techniques for the video collage offer browsing advantages and convenience to the user of the computing device while preserving a storyline.

### BRIEF DESCRIPTION OF THE DRAWINGS

The Detailed Description is set forth with reference to the accompanying figures. The teachings are described with reference to the accompanying figures. In the figures, the left-most digit(s) of a reference number identifies the figure in which the reference number first appears. The use of the same reference numbers in different figures indicates similar or identical items.

FIG. 1 is a block diagram of an exemplary system for a video collage.

FIG. 2 is an overview flowchart showing an exemplary process for the video collage of FIG. 1.

FIG. 3 is a block diagram showing an exemplary video collage with blending edges.

FIG. 4 is a block diagram showing the exemplary video collage of FIG. 3 without seams and in a compact layout.

FIG. 5 is a block diagram showing an exemplary user interface for the video collage.

FIG. 6 is a block diagram of an exemplary system for the video collage of FIG. 1.

### DETAILED DESCRIPTION

### Overview

This disclosure is directed to various exemplary methods, computer program products, and user interfaces for generating a video presentation scheme, by combining regions of interest (ROI) into a video collage. Traditional techniques for video presentations cannot be readily applied towards constructing a video collage, since those conventional techniques typically lack compact layout and have irregular visual shapes showing unsmooth transitions between the shapes. Also, the techniques of creating a picture collage from a collection of images cannot be applied towards constructing a video collage. Differences exist between photo and video, where in video, there is an information-intensive media with more redundancy and with better-organized temporal structures, like scene and shot. Thus, the techniques described for generating a video collage allows automatic construction of a compact and visually appealing synthesized video collage from the video content.

In one aspect, the disclosure is directed towards constructing a video collage from images from a photo collection. The method includes extracting and resizing the images from the photo collection and arranging the images on a canvas according to a timestamp.

In another aspect, the techniques for creating the video collage formulates an energy minimization equation that maximizes representativeness of video content by extracting the regions of interest and minimizes transitions between the regions of interest (ROI) by blending these regions. Thus, the techniques extract and blend the regions of interest (ROI) independently in order for optimization to occur.

In another aspect, a user may experience an interface from the following aspects: a compact and visually appealing synthesized collage from a video sequence for efficient video browsing. The user may browse video content in a variety of more efficient ways such as a one dimensional collage, a two dimensional collage, a dynamic or a static collage, key frames, video clips and video content corresponding to the video collage. Thus, the interface for the video collage offers browsing advantages and a variety of browsing manners to the user.

The described techniques for creating the video collage help improve efficiency and provide convenience for the user by constructing a compact and visually appealing synthesized video collage for efficient video browsing. Furthermore, the video collage supports browsing manner to enable the user to view the video collage, and view a corresponding video content, a corresponding video clip, or corresponding key frames. By way of example and not limitation, the video collage described herein may be applied to many contexts and environments. By way of example and not limitation, the video collage may be implemented on web search engines, search engines, video-sharing sites, video search services, content websites, content blogs, movie sites, media centers, and the like. Furthermore, the video collage may be implemented as a kind of online video service which provides a compact and visually appealing tool for browsing and sharing the video content on the Internet.

### Illustrative Environment

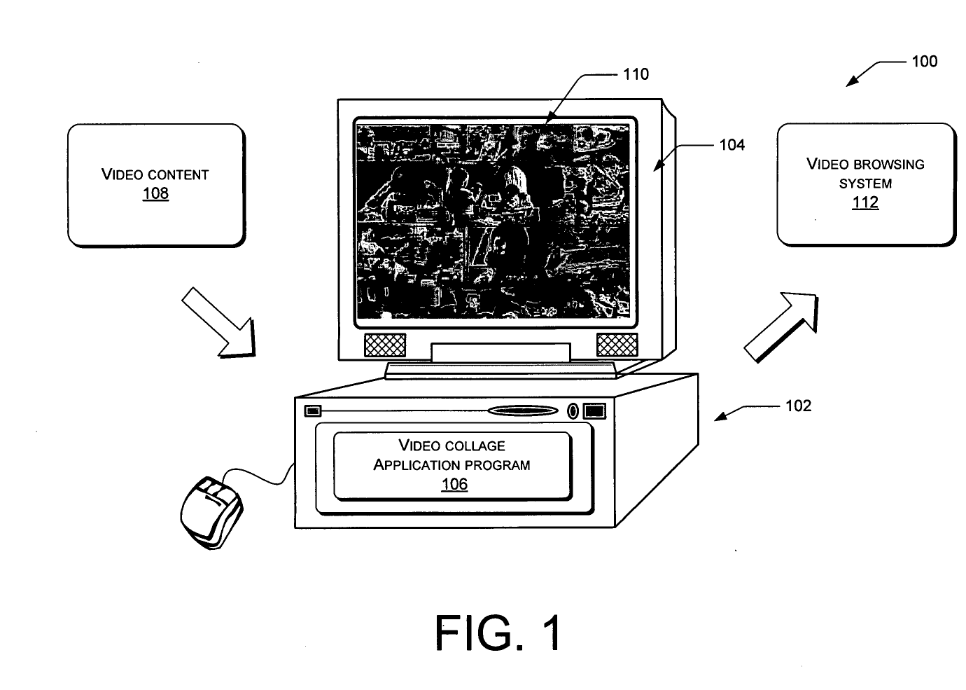

FIG. 1 is an overview block diagram of an exemplary system 100 for generating a compact and visually appealing synthesized video collage, which is broadly applicable to any situation in which it is desirable to construct a video collage from video content. Shown is a computing device 102. Computing devices 102 that are suitable for use with the system 100, include, but are not limited to, a personal computer, a laptop computer, a desktop computer, a digital camera, a personal digital assistance, a cellular phone, a video player, and other types of image source. The computing device 102 may include a monitor 104 to display an exemplary compact synthesized video collage including but not limited to, for browsing purposes.

The system 100 includes creating the video collage as, for example, but not limited to, a tool, a method, a solver, a software, an application program, a service, technology resources which include access to the internet, and the like. Here, the video collage is implemented as an application program 106.

Implementation of the video collage application program 106 includes, but is not limited to, selecting key frames that are representative images of video content 108 and are of high quality as well. The video collage application program 106 makes use of the video content 108 by extracting regions of interest (ROI) from key-frames, which are efficiently packed. The video collage application program 106 enlarges the most salient regions of interest to emphasize the meaningful highlights. Salient regions may describe a relevant part of an image that is a main focus of attention for a typical viewer. The video collage application program 106 arranges the regions of interest without seams and provides transitions between the regions of interest (ROI) that are visually smooth.

The video collage application program 106 preserves a temporal structure of the video content 108 in terms of the layout in a product, in creating the video collage. The video collage application program 106 includes selecting images from the video content 108 and extracting and resizing the regions of interest (ROI) to construct the exemplary video collage 110 which is shown in the display monitor 104. The video collage 110 offers an efficient video browsing system 112.

The video collage search application program 106 generates the exemplary video collage 110 that is applicable towards video browsing 112. Here, the video collage application program 106 will provide a one dimensional collage, a two dimensional collage, a dynamic or a static collage, key frames, video clips and video content corresponding to the video collage 110. The disclosure offers browsing advantages and convenience to the user. The display monitor 104 would show a user interface that allows the user of the computing device to browse through the exemplary video collage 110 and corresponding video clips, corresponding video content, and corresponding key frames.

### Implementation of the Video Collage Program

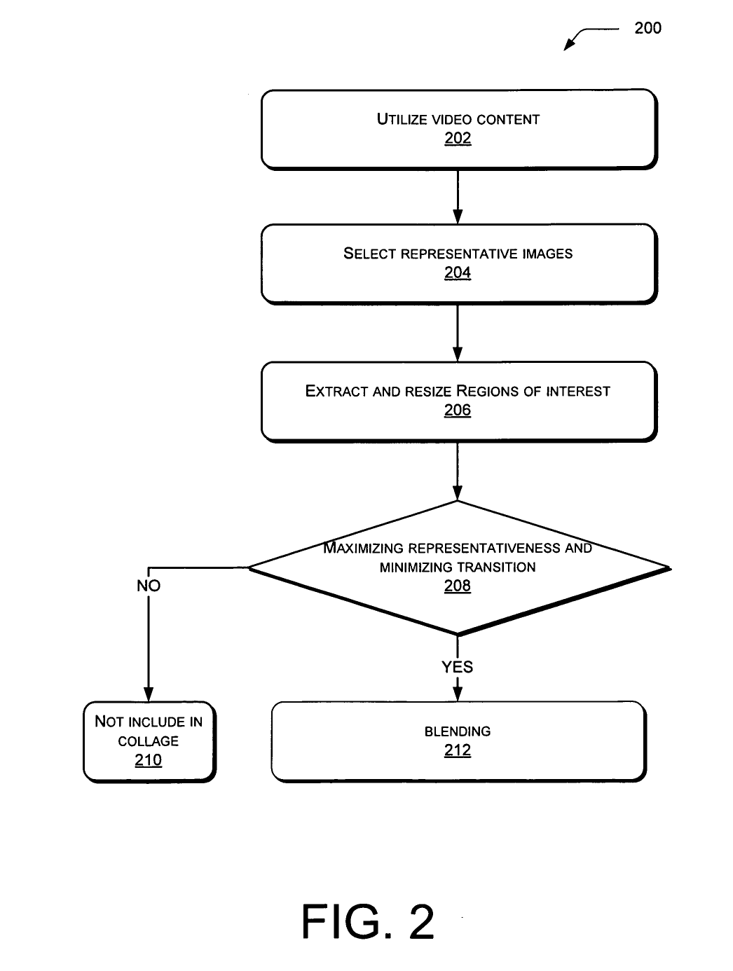

Illustrated in FIG. 2 is an overview exemplary flowchart of a process 200 for implementing the video collage application program 106 to provide a benefit to users by automatically constructing a visually appealing video collage 110. For ease of understanding, the method 200 is delineated as separate steps represented as independent blocks in FIG. 2. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible that one or more of the provided steps will be omitted. The flowchart for the video collage process 200 provides an example of the video collage application program 106 of FIG. 1.

Shown in FIG. 2 at block 202 identifies utilizing a video sequence of a video content 108 in the video collage application program 106. In order to provide efficient browsing of video data, the video collage application program 106 presents a main story of the video, such as an effective summarization of the video content. For example, the process 200 preserves the temporal structure of the video content, which makes for efficient browsing and understanding of the whole video content.

Block 204 illustrates selecting key frames that are representative images of the video content 108 that are of high quality, as well. The video collage application program 106 selects representative images consisting of two parts: optimization-based sub-shot selection and key-frame selection. For example, let Ω⁼{SSi} (i=1, . . . , N_{SS}) which denotes all the sub-shots in a video, Θ denotes a subset of Ω with N sub-shots. Thus, the video collage application program 106 selects representative sub-shots as finding an optimal Θ which minimizes an energy function. Shown below is an equation for finding the optimal Θ which minimizes the energy function

$$- ( α {\sum }_{{SS}_{i} ∈ Θ} A ( {SS}_{i} ) + β {\sum }_{{SS}_{i} ∈ Θ} Q ( {SS}_{i} ) + γ D ( Θ ) )$$

where the three parameters (α, β, γ) have the same constraint as in this equation for representativeness energy: Eᵣₑₚ (λ)=−(αA(λ)+βQ(λ)+γD(λ)). The terms A(SSᵢ), Q(SSᵢ) and D(Θ) have the same meanings as the representativeness equation and can be computed by rewriting the representativeness equation as:

$${E}_{rep} ( λ ) = - {\sum }_{i = 1}^{M} [ α A ( {I}_{i} , {R}_{i} ) + β ( C ( {I}_{i} , {R}_{i} ) - B ( {I}_{i} , {R}_{i} ) ) ] \cdot \frac{ɛ A ( {I}_{i} , {R}_{i} )}{{A}_{max}} - γ D ( λ )$$

except that using the key-frame of each sub-shot instead of Iᵢ. The video application program 106 solves this problem by a heuristic searching algorithm searching for a sub-shot selection. The algorithm is shown as:

Input: N,Ω={SSᵢ}
Output: Θ
while(n ≦ N)do
find the sub-shot SSᵢ with max{A(SSᵢ)+Q(SSᵢ)} in Ω
for each SSₖ in the shot to which SSᵢ is belonging do
A(SSₖ)=A(SSₖ)−1,Q(SSₖ)=Q(SSₖ)−1;Ω=Ω−{SSₖ}
end for
Θ = Θ + {SSᵢ}
n + +;
end while

In a key-frame selection, the number of key-frames to be selected from each sub-shot is decided according to the camera motion in the sub-shot. The video collage application program 106 classifies camera motions into four types: static, pan, tilt, and zoom. Although more than one image is selected from pan/tilt sub-shot, these two images are blended as one region of interest in the final video collage 110.

Video or photo presentation can be classified into two paradigms, framed-based or regions of interest (ROI) based. Framed-based paradigm extracts a set of representative key-frames and then arranges these key-frames into a synthesized image according to a temporal structure. Regions of interest (ROI) extract saliency regions in the key-frames and then arrange the key frames in a static or a dynamic manner. Saliency regions may pertain to a relevant part of an image that is a main focus of attention for a typical viewer. The process 200 enlarges the most salient regions of interest (ROI) to emphasize the meaningful highlights.

In block 206, the process 200 extracts regions of interest (ROI) from the representative key-frames in the video sequence and resizes regions of interest according to their saliency. The regions of interest may be fixed to a shape, including but not limited to a rectangle, a square, a triangle, and the like, and are arranged by a redefined temporal order.

In another implementation, the regions of interest may not be fixed to any particular shape, but may include a free form shape without any defined temporal order. The free form shape supports arbitrary shapes of regions of interest (ROI). For example, the free form shape includes ROI design arrangement schemes that include but is not limited to a book, a diagonal, and a spiral. Furthermore, the spiral order and any other order may include but is not limited to, a circle, a heart, a fan, an ellipse, and a mickey mouse shape. Based on the collage styles for the free form shape, the process may order the pixels in the video collage in sequence, order the ROI according to temporal information or saliencies. The video collage application program 106 provides as much informative information as possible and as little background information for the video collage 110. For example, the video collage application program 106 supplies parts of each key-frame that attracts attention of the user and provides useful information.

Saliency refers to the “importance” or “attractiveness” of the visual information embedded in an image. A salient region may describe a relevant part of an image that is a main focus of a typical viewer's attention. A static image attention model may be adopted to extract ROI based on the saliency map. Then each ROI is resized 206 according to its saliency to emphasize the meaningful highlights.

In an exemplary implementation of the video collage application program 106, an energy minimization is formulated. In this implementation, there is a video sequence V containing M frames (images) {Ii} (i=1, . . . , M) and their corresponding ROI maps {Ri} (i=1, . . . , M). The video collage application program 106 selects N (N<<M) representative images from V and arranges the ROI of these images on a video collage C (video collage 110). For this implementation, λ represents a feasible solution where λ={Iᵢ, Rᵢ} (i=1, . . . , M).

In an exemplary implementation of the video collage application program 106, each ROI Rᵢ has a set of state variables Rᵢ={lᵢ, pᵢ, sᵢ}, where lᵢ is the label of Rᵢ indicating whether Iᵢ is selected (lᵢ=1) or not (lᵢ=0) in C, pᵢ is the spatial position of Rᵢ in C, and sᵢ is the size of Rᵢ after being resized according to its saliency. By the triplet of (lᵢ, pᵢ, sᵢ), the video collage application program 106 determines whether Iᵢ appears in C and how the corresponding Rᵢ is presented in C (i.e. the position and size).

Block 208 represents the video collage application program 106 incorporating several desired properties. In particular, two measurements, i.e., representativeness and transition, are used to solve the issue of regions of interest by extracting and blending these items separately for optimization.

Block 208 represents maximizing representativeness and minimizing transition in which the video collage application program 106 creates an energy minimization equation to find the best λ to minimize an energy or a cost E(λ). The energy minimization equation is: E(λ)=ω₁Eᵣₑₚ(λ)+ω₂Eₜᵣₐₙₛ(λ)

Subject to Σᵢ₌₁^{M}λᵢ=N

where Eᵣₑₚ(λ)denotes the cost from representativeness of λ,Eₜᵣₐₙₛ(λ)denotes the cost of any transition that is not visually smooth, ω₁ and ω₂ are two predefined weights controlling the relative strength of each energy term.

### Representativeness Cost Eᵣₑₚ(λ)

The representativeness cost is associated with how the selected images represent video content. The video collage application program 106 suggests that a saliency, a quality, and a distribution of the selected image set should be taken into account in measuring the representativeness. Therefore, representativeness energy is defined as a combination of each configuration as follows:

Eᵣₑₚ(λ)=−(αA(λ)+βQ(λ)+γD(λ))

where α+β+γ=1,0≦α,β,γ≦1. A(λ),Q(λ) and D(λ) measures the saliency, the quality, and the distribution of the selected images, respectively. In order to incorporate the resizing strategy for each ROI 206, the equation for representativeness energy is rewritten in more details as follows:

$${E}_{rep} ( λ ) = - {\sum }_{i = 1}^{M} [ α A ( {I}_{i} , {R}_{i} ) + β ( C ( {I}_{i} , {R}_{i} ) - B ( {I}_{i} , {R}_{i} ) ) ] \cdot \frac{ɛ A ( {I}_{i} , {R}_{i} )}{{A}_{max}} - γ D ( λ )$$

where A(Iᵢ, Rᵢ) measures the saliency or importance of Iᵢ and can be computed by an image attention model; the quality of Iᵢ, i.e. Q(Iᵢ, Rᵢ), is derived from color contrast C(I_{i,} Rᵢ) and blurring degree B(Iᵢ, Rᵢ); Aₘₐₓ is the maximal saliency in λ;ε(1≦ε≦2) is a constant to control the resizing of ROI of Iᵢ. D(λ) measures a temporal distribution of λ, where the sense of selected images are uniformly distributed such that the content can be preserved as more as possible. Thus, D(λ) can be defined as:

$$D ( λ ) = - \frac{1}{log N} {\sum }_{i = 1 , {λ}_{i} \neq 0}^{N - 1} p ( {I}_{i} , {R}_{i} ) \cdot log p ( {I}_{i} , {R}_{i} )$$

where p(Iᵢ, Rᵢ)=(interval between Iᵢ and _{Ii+1})/(the total duration of video). Intuitively, the larger D(λ) is, the more uniform the distribution of λ is.

### Transition Cost Eₜᵣₐₙₛ(λ)

The video collage application program 106 desires a compact and seamless layout of λ in C by minimizing the transition energy item Eₜᵣₐₙₛ(λ). Given the selected collection of ROI {Rᵢ}(i=1, . . . , M) and collage C, the arrangement of ROI in the collage is expressed as finding an optimal ROI for each pixel p in C, thus p is from one of ROI in λ. The mapping between pixels and source ROI is known as a labeling and denote the label for each pixel L(p), where L(p)∈{1,2, . . . , M}. The video collage application program 106 detects a seam between two neighboring pixels p, q in C if L(p)≠L(q). The video collage application program 106 resizes each ROI in the final collage by a bilinear interpolation according to its saliency, given the spatial layout of selected ROI in C. The video collage application program 106 proposes measuring the transition cost as the sum of color differences across the seams of the resized neighboring ROI:

$${E}_{trans} ( λ ) = {\sum }_{p , q ∈ C} ( ‖ {R}_{L ( p )}^{′} ( p ) - {R}_{L ( q )}^{′} ( p ) ‖ + ‖ {R}_{L ( p )}^{′} ( q ) - {R}_{L ( q )}^{′} ( q ) ‖ )$$

where R′_{L(p)}(q) denotes the color of pixel q(q ∈ C) in the resized ROI R′_{L(p)}.

If the conditions for the maximization of representativeness and the minimization of transition conditions are not satisfied, then the process flow 200 takes a NO branch to block 210 which does not include or use these images as part of constructing the video collage 110.

Returning to block 208, if the conditions for the maximization of representativeness of the regions of interest and the minimization of transition of the ROI conditions are satisfied, then the process flow 200 takes a YES branch to block 212 which includes or uses these regions of interest in constructing the video collage.

From block 208, the process may proceed to block 212 for blending. Based on the above ROI selection and resizing operations, an optimal set of ROI is obtained which minimizes Eᵣₑₚ(λ). To construct a video collage with compact and visually appealing form, the ROI selected should be seamlessly blended to minimize Eₜᵣₐₙₛ(λ), with the following properties:
(1) the spatial layout should be consistent with the temporal order of the selected ROI. Thus, the temporal structure of ROI in the spatial layout is preserved “left to right” and “top to down”;
(2) the ROI within the same sub-shot should be blended according to the camera motion. Thus, the ROI within the same sub-shot represents the pan by horizontally blending and tilt by vertically blending the images from the same sub-shot;
(3) all of the ROI should not be overlapped; and
(4) all of the neighboring ROI should satisfy the seamless transition.

Two conditions, all of the ROI should not be overlapped and all of the neighboring ROI satisfy the seamless transition can be met as follows. The ROI is first put onto the video collage 110 compactly according to the criterion that the spatial layout should be consistent with the temporal order of the selected ROI and all of the ROI should not be overlapped. Then the transition is represented between the neighboring ROI by low-order statistics with spatial mean and covariance, which is interpreted as a Gaussian model.

There may be times where there is an image with seams. For neighboring pixels p and q, if L(p )≠L(q), a seam exists between them. If there is a seam between S and T, which are two small blending areas (i.e. the area with the distance of less than 20 pixels to the seam) close to the seam of two neighboring ROI Ri and Rj, the ROI blending is performed on S and T. To be exact, for pixels p in S or T, the probabilistic density fₛ(p) and f_{T}(p) according to Gaussian distribution is:

$${f}_{s} ( p ) = \frac{exp [ - \frac{{( p - {μ}_{S} )}^{2}}{2 {σ}^{2}} ]}{\sqrt{2 πσ}} , \\ {f}_{T} ( p ) = \frac{exp [ - \frac{{( p - {μ}_{T} )}^{2}}{2 {σ}^{2}} ]}{\sqrt{2 πσ}}$$

$${μ}_{S} {∞ ( \frac{p - a}{b - p} )}^{2} \times p , \\ {μ}_{T} {∞ ( \frac{b - p}{p - a} )}^{2} \times p$$

where μ_{S}, and μ_{T} are the means of neighboring area of p in S or T, a and b are the edges of S and T. Then, for pixel ₚ_{_{b}} in S or T to be blended, the value after blending I(p b) can be computed as follows:

$$I ( {p}_{b} ) = {I}_{s} ( p ) {P}_{S} ( p ) + {I}_{T} ( p ) {P}_{T} ( p )$$

$$\{ \begin{matrix}if ( {p}_{b} ∈ S ) \{ \begin{matrix}{I}_{S} ( p ) = {I}_{S} ( {p}_{b} ) , {I}_{T} ( p ) = {I}_{T} ( seam ) \\ {P}_{S} ( p ) = {\int }_{a \leq p \leq {p}_{b}} {f}_{s} ( p ) d p \\ {P}_{T} ( p ) + 1 - {P}_{S} ( p )\end{matrix} \\ f ( {p}_{b} ∈ T ) \{ \begin{matrix}{I}_{T} ( p ) = {I}_{T} ( {p}_{b} ) , {I}_{S} ( p ) = {I}_{S} ( seam ) \\ {P}_{T} ( p ) = {\int }_{b \leq p \leq {p}_{b}} {f}_{T} ( p ) d p \\ {P}_{S} ( p ) = 1 - {P}_{T} ( p )\end{matrix}\end{matrix}$$

where Iₛ(p) and I_{T}(P) denotes the value of p in S and T before blending, respectively.

### Exemplary Video Collage

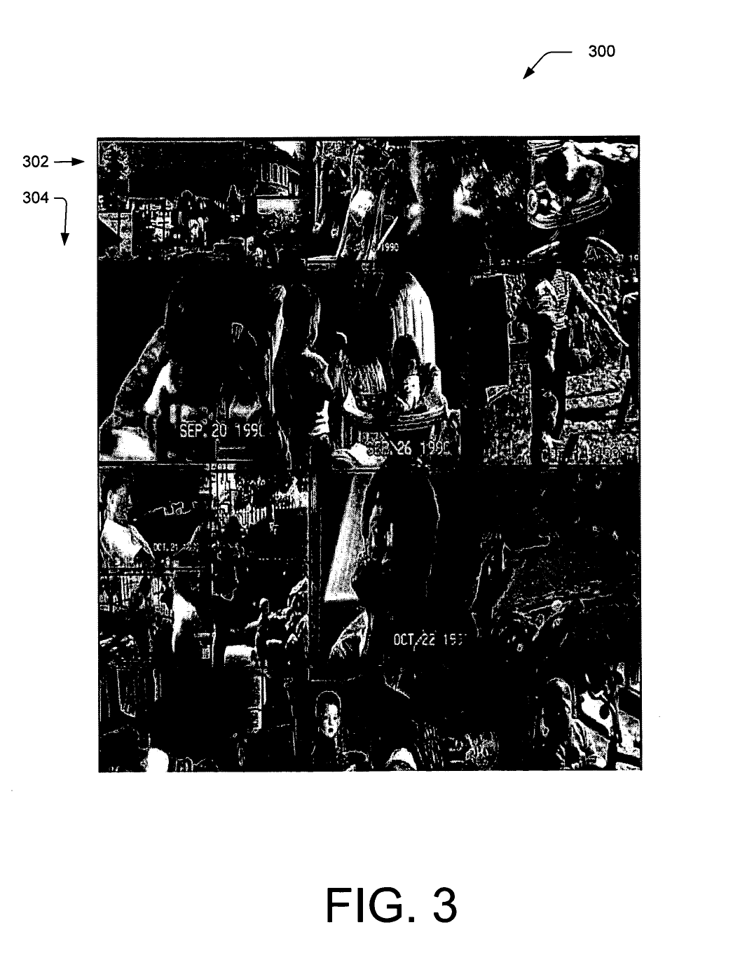

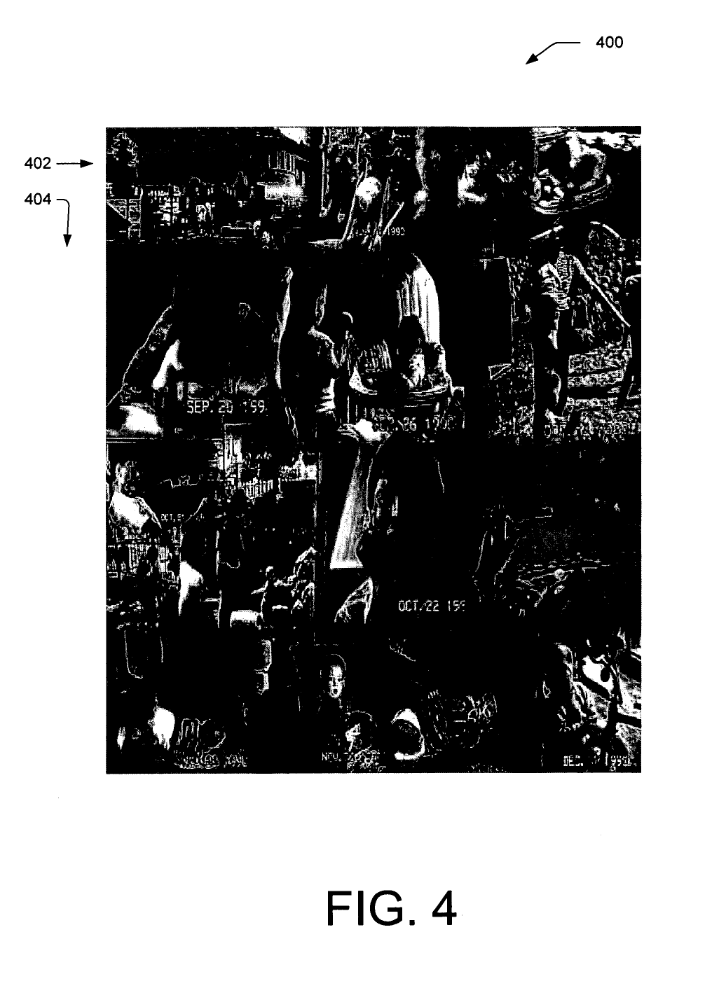

FIGS. 3 and 4 illustrate exemplary video collages. FIG. 3 illustrates a two dimensional video collage of a home video with blending edges 300 and FIG. 4 illustrates the exemplary video collage of FIG. 3 without any blending edges.

FIG. 3 shows an exemplary two dimensional video collage with ROI blending edges of a home video sequence 300. The ROI are excerpted from the representative key-frames which are selected from the original video, resized according to the salience, and then arranged without any seams in the video collage 300. In an exemplary implementation, the video may include but is not limited to, thirty video sequences with 3k shots and 50k sub-shots and the number of ROI may include but is not limited to, ranging from ten to thirty ROI. The temporal structure of the video content is preserved in the order of “left to right” layout 302 and “top to down” layout 304 as shown in the two dimensional video collage 300.

FIG. 4 shows the exemplary two dimensional video collage of the home video sequence 400. The two dimensional video collage 400 corresponds to the two dimensional video collage 300 shown in FIG. 3, but shown without any blending edges. The temporal structure of the video content is preserved in the order of “left to right” layout 402 and “top to down” layout 404 as shown in the two dimensional video collage 400.

### Exemplary Video Collage Interface

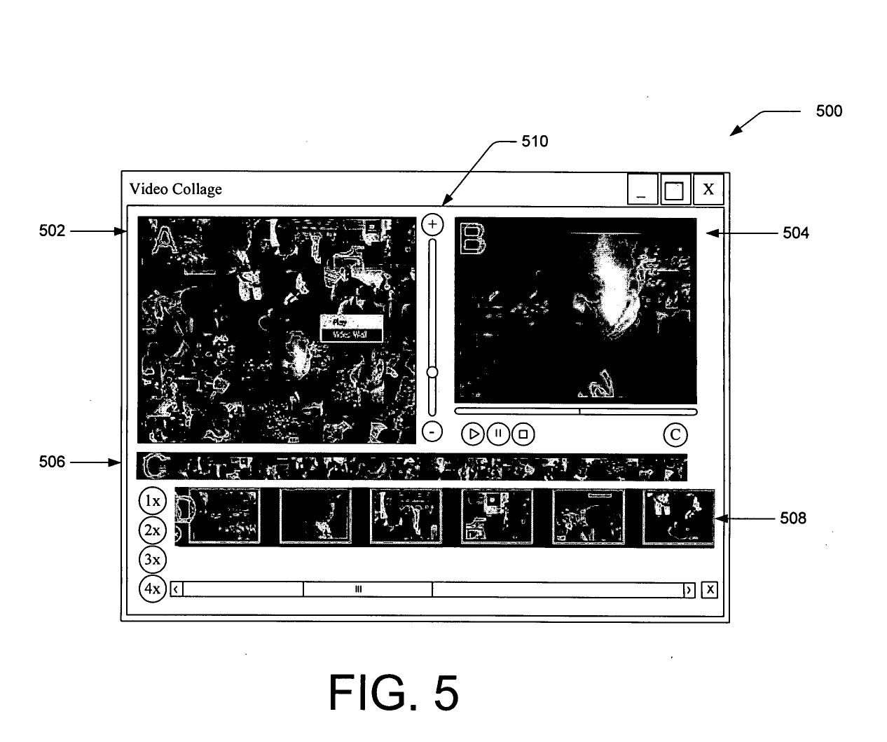

FIG. 5 illustrates an exemplary video collage user interface 500 for the video collage application program 106. FIG. 5 shows a novel video browsing system with a user interface 500. The user interface may include but is not limited to four separate panels, shown as panel A at 502, panel B at 504, panel C at 506, and panel D at 508. The users can change collage resolution (i.e., the number of ROI in the video collage) by moving the marker 510 on the slide bar (i.e., the bar between panel A at 502 and panel B at 504) vertically to view the video collage content in different resolution.

In one aspect, the video collage user interface 500 supports a two dimensional static collage. For example, the two dimensional collage may be shown in panel A at 502. By the user left clicking on a specific ROI, the user may access the corresponding video content shown in panel B at 504.

In another aspect, the video collage user interface 500 supports a two dimensional dynamic collage. For example, the two dimensional collage may be shown in panel A at 502. By the user right-clicking on a specific ROI, the user may select playing a corresponding video clip in panel A at 502 or playing all of the clips in panel A at 502 on a pop-up menu. There are thumbnails corresponding to a short video clip. Advantages of this representation are that the video collage 110 is composed of ROI which makes the collage more compact, the thumbnails in the collage are resized according to saliencies, and the video collage is designed for a single video.

In another aspect, the video collage user interface 500 supports a one dimensional static collage. For example, the one dimensional collage may be shown in panel C at 506. By the user left clicking on a specific ROI, the user may access the corresponding video content shown in panel B at 504.

In another aspect, the video collage user interface 500 supports a one dimensional dynamic collage. For example, the one dimensional collage may be shown in panel C at 506. By the user right-clicking on a specific ROI, the user may select playing a corresponding video clip in panel A at 502 or playing all of the clips in panel A at 502 on a pop-up menu.

In another implementation, the video collage user interface 500 supports key-frames. For example, the user may view key-frames in panel D at 508 and click on a specific key-frame to access the corresponding video content in panel B at 504. Through these different methods on the video collage user interface 500, the users can browse the video content very efficiently.

### Video Collage System

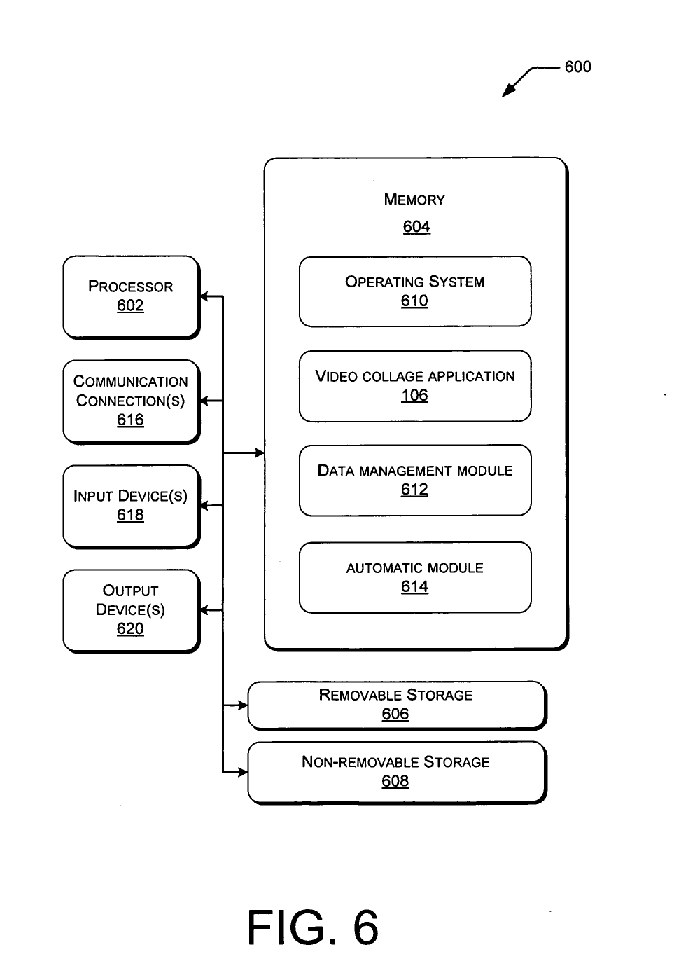

FIG. 6 is a schematic block diagram of an exemplary general operating system 600. The system 600 may be configured as any suitable system capable of implementing the video collage application program 106. In one exemplary configuration, the system comprises at least one processor 602 and memory 604. The processing unit 602 may be implemented as appropriate in hardware, software, firmware, or combinations thereof. Software or firmware implementations of the processing unit 602 may include computer- or machine-executable instructions written in any suitable programming language to perform the various functions described.

Memory 604 may store programs of instructions that are loadable and executable on the processor 602, as well as data generated during the execution of these programs. Depending on the configuration and type of computing device, memory 604 may be volatile (such as RAM) and/or non-volatile (such as ROM, flash memory, etc.). The system may also include additional removable storage 606 and/or non-removable storage 608 including, but not limited to, magnetic storage, optical disks, and/or tape storage. The disk drives and their associated computer-readable medium may provide non-volatile storage of computer readable instructions, data structures, program modules, and other data for the communication devices.

Memory 604, removable storage 606, and non-removable storage 608 are all examples of the computer storage medium. Additional types of computer storage medium that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 102.

Turning to the contents of the memory 604 in more detail, may include an operating system 610, one or more video collage application program 106 for implementing all or a part of the video collage method. For example, the system 600 illustrates architecture of these components residing on one system or one server. Alternatively, these components may reside in multiple other locations, servers, or systems. For instance, all of the components may exist on a client side. Furthermore, two or more of the illustrated components may combine to form a single component at a single location.

In one implementation, the memory 604 includes the video collage application program 106, a data management module 612, and an automatic module 614. The data management module 612 stores and manages storage of information, such as images, ROI, equations, and the like, and may communicate with one or more local and/or remote databases or services. The automatic module 614 allows the process to operate without human intervention. For example, the automatic module 614 in an exemplary implementation, may allow the video collage application program 106 to automatically construct a compact synthesized collage from a video sequence, and the like.

The system 600 may also contain communications connection(s) 616 that allow processor 602 to communicate with servers, the user terminals, and/or other devices on a network. Communications connection(s) 616 is an example of communication medium. Communication medium typically embodies computer readable instructions, data structures, and program modules. By way of example, and not limitation, communication medium includes wired media such as a wired network or direct-wired connection, and wireless media such as acoustic, RF, infrared and other wireless media. The term computer readable medium as used herein includes both storage medium and communication medium.

The system 600 may also include input device(s) 618 such as a keyboard, mouse, pen, voice input device, touch input device, etc., and output device(s) 620, such as a display, speakers, printer, etc. The system 600 may include a database hosted on the processor 602. All these devices are well known in the art and need not be discussed at length here.

The subject matter described above can be implemented in hardware, or software, or in both hardware and software. Although embodiments of click-through log mining for ads have been described in language specific to structural features and/or methodological acts, it is to be understood that the subject matter defined in the appended claims is not necessarily limited to the specific features or acts described above. Rather, the specific features and acts are disclosed as exemplary forms of exemplary implementations of click-through log mining for ads. For example, the methodological acts need not be performed in the order or combinations described herein, and may be performed in any combination of one or more acts.

1. A method for constructing a video collage, implemented at least in part by a computing device, the method comprising:
selecting representative images from a video content;
extracting and resizing regions of interest (ROI) from the representative images from the video content; and
arranging the regions of interest on a canvas and preserving a temporal structure of the regions of interest.

2. The method of claim 1, further comprising formulating an energy minimization equation to maximize representativeness of the video content and to minimize transition between the regions of interest.

3. The method of claim 1, wherein selecting representative images comprises measuring a saliency, a quality, and a distribution of a selected image, wherein the saliency is based on an importance of a visual information embedded in a selected image.

4. The method of claim 1, wherein resizing the regions of interest comprises using a bilinear interpolation based on a saliency of an image, such that the saliency is based on an importance of a visual information embedded in the image.

5. The method of claim 1, wherein arranging the regions of interest comprises the ROI within a same sub-shot is blending based on a camera motion, the ROI do not overlap, and a neighboring ROI are in a seamless transition.

6. The method of claim 1, wherein the temporal structure of the video content is consistent with a spatial layout of a selected region of interest, wherein the spatial layout includes a left to a right layout and a top to a down layout.

7. The method of claim 1, wherein arranging the regions of interest comprises arbitrary shaped regions of interest with design styles that include a book, a diagonal, or a spiral.

8. The method of claim 1, further comprising using a Gaussian distribution to avoid overlapping the regions of interest.

9. The method of claim 1, further comprising the regions of interest within a same sub-shot is blended based on a camera motion, wherein the camera motion includes panning by horizontally blending and tilting by vertically blending the images from the same sub-shot.

10. A computer-readable storage media comprising computer-executable instructions that, when executed, perform the method as recited in claim 1.

11. A computer-readable storage media comprising computer-readable instructions executed on a computing device, the computer-readable instructions comprising instructions for:
utilizing a video content to select representative images from the video content;
generating a video collage from the video content by extracting and resizing regions of interest (ROI) from representative images, wherein the ROI is based on an importance of a visual information embedded in the representative images;
preserving a temporal structure of the video content; and
creating the video collage with the regions of interest on a canvas and in a compact layout.

12. The computer-readable storage media of claim 11, further comprising formulating an energy minimization equation to find a λ to minimize an energy or cost E(λ) such that
E(λ)=ω₁Eᵣₑₚ(λ)+ω₂Eₜᵣₐₙₛ(λ)
Subject to Σᵢ₌₁^{M}λᵢ=N
where Erep(λ) denotes a cost from representativeness of λ,Eₜᵣₐₙₛ(λ) denotes the cost of any transition that is not visually smooth, ω₁ and ω₂ are two predefined weights controlling a relative strength of each energy term.

13. The computer-readable storage media of claim 11, further comprising formulating an equation for representing cost to determine how to select images representing video content, wherein the equation includes:
Eᵣₑₚ(λ)=−(αA(λ)+βQ(λ)+γD(λ)),
wherein α+β+γ=1,0≦α,β, γ≦1, and A(λ),Q(λ) and D(λ) measures a saliency, a quality and a distribution of the selected images, respectively.

14. The computer-readable storage media of claim 11, wherein resizing regions of interest comprises formulating an equation:
$${E}_{rep} ( λ ) = - {\sum }_{i = 1}^{M} [ α A ( {I}_{i} , {R}_{i} ) + β ( C ( {I}_{i} , {R}_{i} ) - B ( {I}_{i} , {R}_{i} ) ) ] \cdot \frac{ɛ A ( {I}_{i} , {R}_{i} )}{{A}_{max}} - γ D ( λ )$$
where A(Iᵢ,Rᵢ) measures a saliency or importance of Ii; a quality of Iᵢ, Q(Ii,Rᵢ), is derived from a color contrast C(Iᵢ,Rᵢ) and a blurring degree B(Iᵢ, Rᵢ); Amax is a maximal saliency in λ; ε (1≦ε≦2) is a constant to control a resizing of ROI of Iᵢ.

15. The computer-readable storage media of claim 14, wherein D(λ) measures a temporal distribution of λ, wherein D(λ) can be defined as
$$D ( λ ) = - \frac{1}{log N} {\sum }_{i = 1 , {λ}_{i} \neq 0}^{N - 1} p ( {I}_{i} , {R}_{i} ) \cdot log p ( {I}_{i} , {R}_{i} )$$
wherein p(Iᵢ, Rᵢ)=(interval between Iᵢ and Iᵢ₊₁)/(a total duration of a video).

16. The computer-readable storage media of claim 11, wherein creating the video collage comprises minimizing a transition energy Eₜᵣₐₙₛ (λ) by formulating an equation:
$${E}_{trans} ( λ ) = {\sum }_{p , q ∈ C} ( ‖ {R}_{L ( p )}^{′} ( p ) - {R}_{L ( q )}^{′} ( p ) ‖ + ‖ {R}_{L ( p )}^{′} ( q ) - {R}_{L ( q )}^{′} ( q ) ‖ )$$
wherein R′_{L(p)}(q) denotes a color of pixel q(q ∈ C) in a resized ROI R′_{L(p)}.

17. The computer-readable storage media of claim 11, wherein the ROI is resized according to a saliency to emphasize meaningful highlights using equation:
$$size ( {R}_{i}^{′} ) = size ( {R}_{i} ) \frac{ɛ A ( {R}_{i} )}{{A}_{max}}$$
wherein size(Rᵢ) denotes a size of an original ROI, size(R′ᵢ) denotes a size of a resized ROI, and Amax denotes a maximal saliency in λ.

18. A user interface having computer-readable instructions that, when executed by a computing device, cause the computing device to perform acts comprising:
designing a video collage for video browsing;
generating the video collage in a first panel with regions of interest from representative images on a canvas without seams;
presenting access to the video collage in the first panel to play a corresponding video content in a second panel, wherein the video collage in the first panel is shown in a two dimensional static collage; and
presenting access to the video collage in the first panel to play a corresponding video clip in the first panel, wherein the video collage in the first panel is shown in a two dimensional dynamic collage.

19. The user interface of claim 18, wherein the instructions further cause presenting access to the video collage in the first panel to play a corresponding video content in a third panel, wherein the video collage in the first panel is shown in a one dimensional static collage.

20. The user interface of claim 18, wherein the instructions further cause presenting access to the video collage in the first panel to play a corresponding video clip in a third panel, wherein the video collage in the first panel is shown in a one dimensional dynamic collage.

21. The user interface of claim 18, wherein the instructions further cause generating key frames in a fourth panel by clicking on a specific key-frame to access the corresponding video content in the second panel.

22. A method for constructing a video collage, implemented at least in part by a computing device, the method comprising:
selecting images from a photo collection;
extracting and resizing the images from the photo collection; and
arranging the images on a canvas according to a timestamp.
